(19) United States
(12) Patent Application Publication
(10) Pub. No.: US 2003/0029939 A1
(43) Pub. Date: Feb. 13, 2003

(54) No drip valve

(76) Inventors: Theresa Scalzi, Concord, MA (US); Ralph Stankowski, Westford, MA (US); Gregory Straeffer, N. Chelmsford, MA (US)

Correspondence Address: Kevin S. Lemack, Nields & Lemack, 176 E. Main Street, Westboro, MA, 01581, US

(21) Appl. No.: 09/924,921

(22) Filed: Aug. 8, 2001

(51) Int. Cl. B05B 1/30

(52) U.S. Cl. 239/571

(57) ABSTRACT

Fluid separation assembly that allows easy and fast change-out and minimizes or eliminates leakage during change-out. A fluid separation unit having a housing containing separation means, the housing having an inlet and an outlet spaced from the inlet, each including a fitting for attachment of the housing to a manifold or other device allowing fluid communication through the separation means to a point of use is provided. The fittings are designed for quick connect/disconnect, and for minimal or no leakage. The fittings may be on opposite ends, with top and bottom fittings of different configurations, thereby ensuring proper installation of the assembly. The particular medium to be separated is not particularly limited, and can include slurries, fluids including water, and pre-loaded chromatography columns. A one-way self-sealing valve is used to allow flow from the inlet to the outlet upon application of a pressure differential to one side of the valve. Application of a pressure differential to the opposite side of the valve does not allow flow, thereby preventing leakage.

### BACKGROUND OF THE INVENTION

Fluid separation units with fittings may be installed in small spaces that make it very difficult to change out the filter unit. In addition, conventional disposable fluid separation devices can leak during change-out. Since the chemicals used in a particular process may be hazardous, any leakage is undesirable, both from an environmental standpoint, operator safety, and potential damage of equipment components and products. Similarly, tubing associated with the device can leak or drip during change-out, also potentially resulting in a hazardous condition.

Chemical Mechanical Planarization (CMP) of wafers is dependent on the quality and uniformity of the slurry running through the system. Typically, slurry enters the system after it flows through a housing packed with media. The media is designed to filter the slurry in order to ensure the quality of the slurry so as to minimize the chance of defects on the wafers. The slurry consists of very fine particles in an aqueous solution.

Once the filter exhibits a predetermined increase in differential pressure, the operator knows that the filtration media has reached the end of its effective life, and the filter must be removed from the CMP tool and replaced. Since the filter is typically vertically oriented, once the filter is removed, gravity will force any residual slurry in the housing out the inlet that is located at the bottom of the housing. This can damage the tool and/or the wafer being processed, and pose a hazardous condition.

It is therefore an object of the present invention to provide a fluid separation assembly that can be installed inside a CMP tool, the assembly minimizing or eliminating flow of fluid out of the assembly upon removal.

It is yet a further object of the present invention to provide a separation assembly that includes dripless connections, minimizing or preventing leakage during change-out.

### SUMMARY OF THE INVENTION

The problems of the prior art have been overcome by the present invention, which provides a fluid separation assembly that includes one or more no-drip valves, thereby minimizing or eliminating leakage during change-out. In addition, in view of the minimization or absence of leakage, the assembly is adapted to be installed in the CMP tool rather than outside of the tool. According to a preferred embodiment of the present invention, a fluid separation unit having a housing containing separation media, the housing having a first end and a second end spaced from the first end, each of said first and second ends including a fitting for attachment of the housing to a manifold or other device allowing fluid communication through the separation means to a point of use is provided. The fittings are designed for minimal or no leakage. The top and bottom fittings may be of the same or different configurations. Each or only one may contain a valve. The particular medium to be separated is not particularly limited, and can include slurries and fluids including aqueous fluids.

### BRIEF DESCRIPTION OF THE DRAWINGS

FIG. 1 is a schematic representation of the flow layout of a filter housing used in a Chemical Mechanical Planarization process;

FIG. 2 is a cross-sectional representation of a valve and coupling in accordance with a first embodiment of the present invention;

FIG. 3 is a perspective view of the valve and coupling of FIG. 2;

FIG. 4 is a cross-sectional exploded view of a valve and coupling in accordance with a second embodiment of the present invention;

FIG. 5 is a perspective exploded view of the valve and coupling of FIG. 4;

FIG. 6 is a cross-sectional view of a valve and coupling in accordance with a third embodiment of the present invention;

FIG. 7 is a perspective exploded view of the valve and coupling of FIG. 6;

FIG. 8 is a cross-sectional view of a valve and coupling in accordance with a fourth embodiment of the present invention;

FIG. 9 is a perspective exploded view of the valve and coupling of FIG. 8;

FIG. 10 is a perspective view of the valve of FIG. 8 in the normally closed position; and

FIG. 11 is a perspective view of the valve of FIG. 8 in the open position.

### DETAILED DESCRIPTION OF THE INVENTION

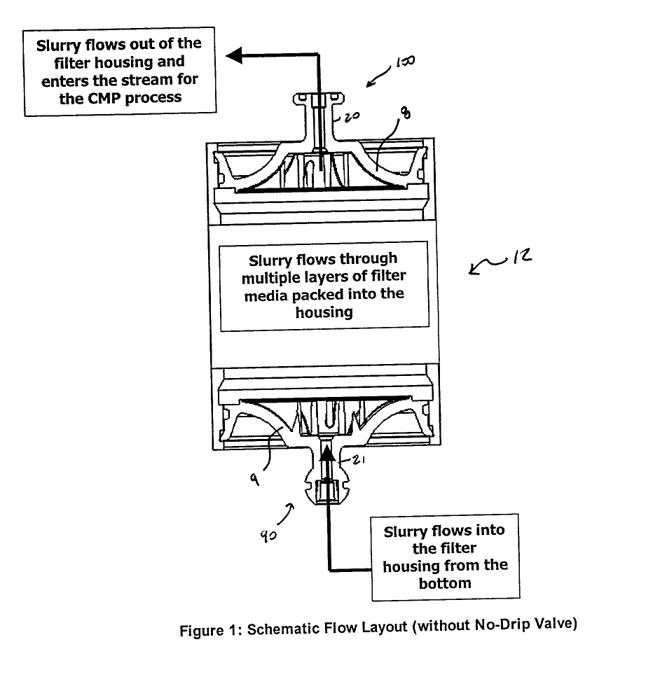

FIG. 1 shows a schematic layout of a conventional fluid separation system in which the present invention may be applied. Those skilled in the art will appreciate that the separation systems of the present invention include filters, purifiers, concentrators and contactors (e.g., degassers and ozonators). For purposes of illustration, the separations systems will be exemplified with filters, although the present invention is not to be limited thereto.

A filter 12 is shown having an inlet end 90 and an outlet end 100 (these could be reversed), each for respective connection to lower and upper manifolds or the like. The filter units 12 may be completely disposable, or may comprise a reusable housing having a disposable inner cartridge. In the embodiment shown in FIG. 1, the first (top) end of each filter unit 12 has a male fitting or coupling 20 forming part of end cap 8, the coupling 20 preferably being centrally located (with respect to the housing of said filter 12) and preferably cylindrical, for attachment to an upper manifold or the like. Similarly, the second (bottom) end of each filter unit 12, which is spaced from and preferably opposing the first end, has a fitting or coupling 21 forming part of end cap 9, the coupling 21 also preferably being centrally located, for attachment to a lower manifold or the like. Slurry flows into the filter housing 12 from the bottom inlet 90 and out of the filter housing 12 through the outlet 20, where it enters the stream for CMP processing. The nature of the slurry is not particularly limited, but typically in CMP applications is comprised of 0.1-0.2 μm diameter clay-like particles such as silica or alumina oxide. Each end cap 8, 9 seals in the filter unit 12.

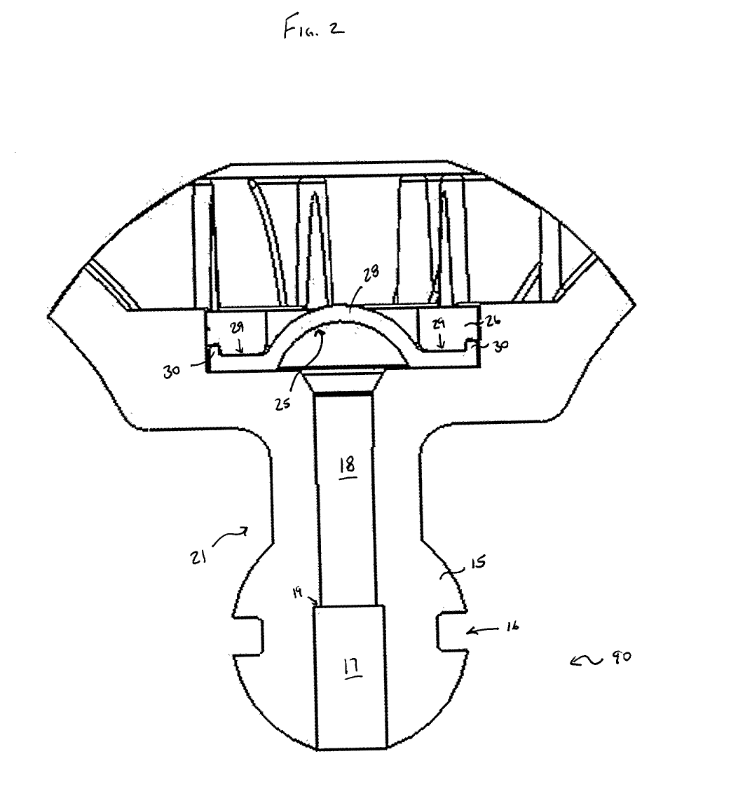

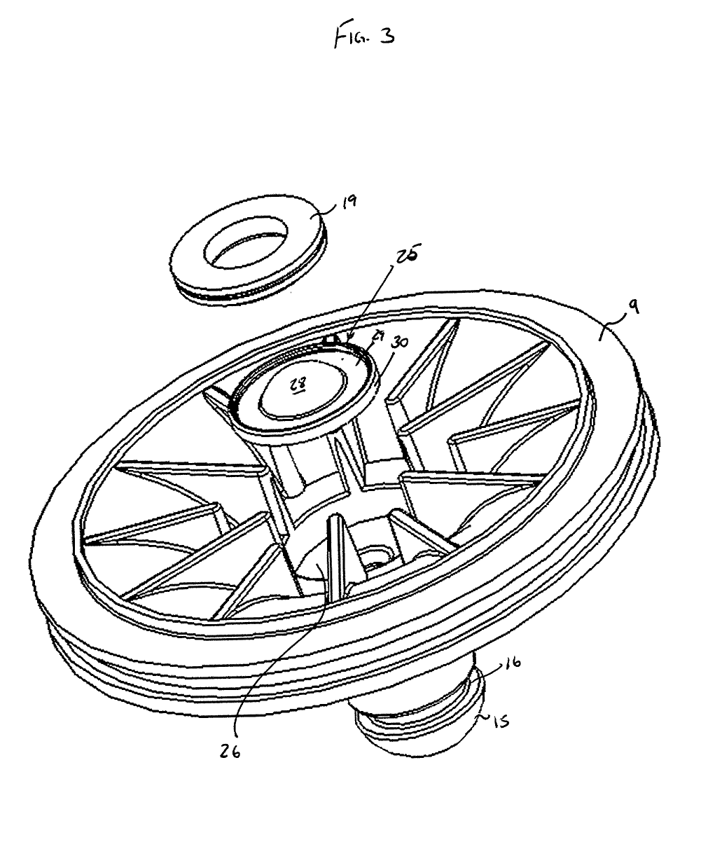

Turning now to FIGS. 2 and 3, there is shown a first embodiment of the no-drip valve in accordance with the present invention. The design allows the valve to be molded from an elastomeric material, although other manufacturing techniques can be used. The coupling 21 on end cap 9 includes a spherical or ball-shaped member 15 having an annular slot 16 adapted to receive an O-ring or the like to seal the inlet such as in a corresponding recess in a manifold. A central inlet 17 is formed in the spherical member 15. The inlet 17 narrows at shoulder 19 into passageway 18 and is in fluid communication with the interior of the housing via passageway 18 (when valve 25 is open as discussed below). Those skilled in the art will appreciate that the difference in diameter between inlet 17 and passageway 18 is not for functional purposes; it is the result of two core pins of different diameters mating, for tooling purposes (i.e., ease of manufacture).

Valve 25 seats in bore 26 formed in the coupling and in fluid communication with passageway 18 as shown. The valve 25 can be composed of a resiliently flexible material, such as melt processable rubber, a thermoplastic elastomer, silicone, or a urethane. It should have a low durometer and a low compression set, and should be inert to the fluids used in the application. The valve 25 preferably includes a central dome 28 extending from a substantially planar annular base 29 with an outer annular lip 30 rising above the substantially planar base. The dome 28 of the valve 25 has one or more slits which are normally closed (i.e., are in close contact so as to prevent the flow of fluid through them). Upon the influence of a pressure differential on opposite sides of the dome 28 caused by fluid flowing from inlet 17 into passageway 18 and bore 26, the slits separate and thereby provide fluid communication into the interior of the housing to which the coupling 21 is attached. Upon elimination of the pressure differential, the slits assume their normally closed position. The valve 25 is thus self-sealing. Because of the shape of the dome 28, a pressure differential on opposite sides of the dome 28 caused by the force of fluid head height in the direction from the housing towards the inlet 17 does not cause the slits to separate, and thus does not provide fluid communication from the interior of the housing to the passageway 18 or inlet 17 even upon mild impact of the housing (unless that pressure differential is sufficient to invert the dome and cause the slits to separate, such as during a backwashing procedure).

A retainer ring 19 (FIG. 3) is donut-shaped and has a central bore 32 configured to receive dome 28. The retainer ring 19 is positioned in bore 26 over the valve 25 to hold the valve 25 in place. The retainer ring 19 is preferably rigid, and can be made of a polyolefin, copolymers or a metal. Preferably it is dimensioned so that an interference fit or snap fit is formed when placed in bore 26.

Although the valve 25 is illustrated as being positioned in the bottom fitting of the housing, a valve also could be used in the top fitting of the housing, or valves could be used in both the top and bottom fittings.

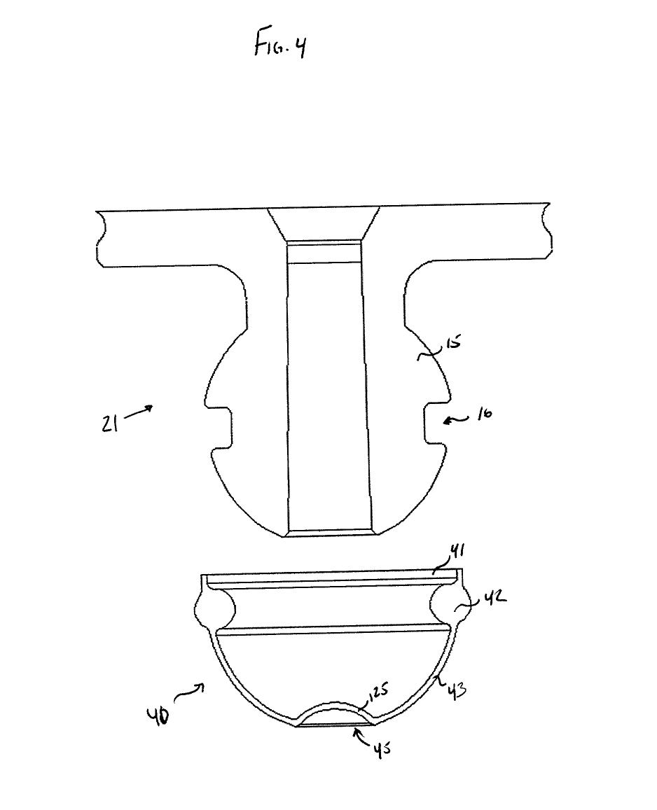

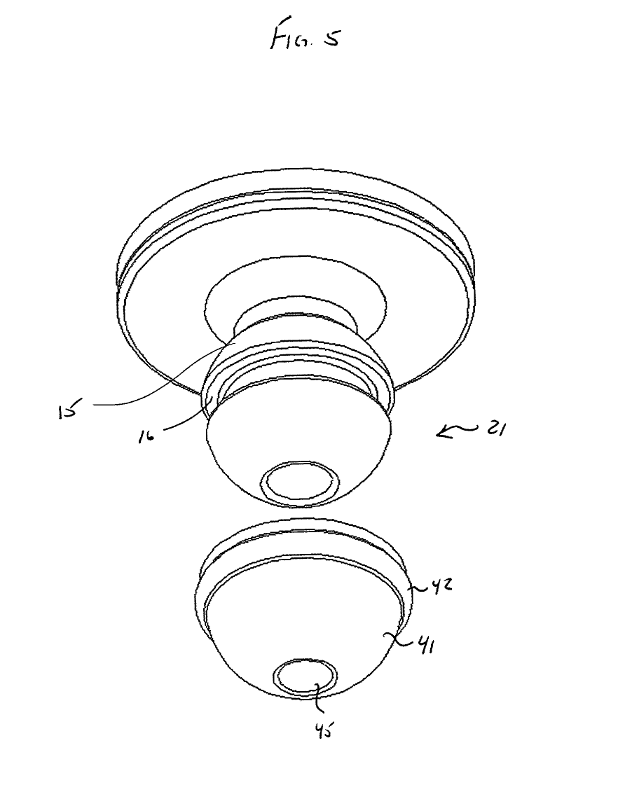

Turning now to FIGS. 4 and 5, an alternative embodiment of the present invention is illustrated. Coupling 21 is similar to the embodiment of FIG. 2, with a spherical member 15 and a slot 16 adapted to receive an O-ring or the like to seal the coupling in the receiving manifold. In this embodiment, the valve and O-ring assembly 40 form one integral piece. The assembly 40 includes annular O-ring 42 and valve 125, which is domed and positioned over aperture 45 in cover cap 41. The dome has one or more slits as in the embodiment of FIG. 2. The valve 125 attaches to annular O-ring via a thin webbing 43 to form a semi-circular integral assembly as shown. Cover cap 41 assembles to the exterior of the spherical member 15 such as by a snap fit. This embodiment places the valve 125 close to the aperture 45, thereby reducing the hold-up volume in the coupling, further minimizing leakage through the aperture 45. Again, the bottom fitting is illustrated by way of example only; a valve could be located in the top fitting or in both the top and bottom fittings.

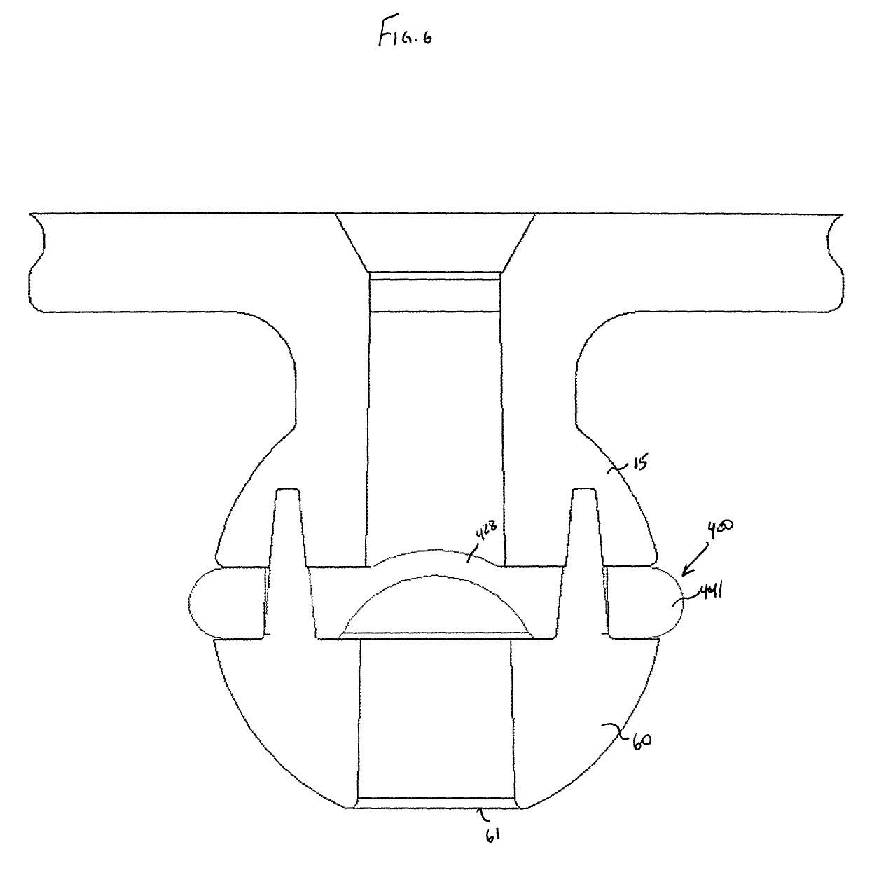

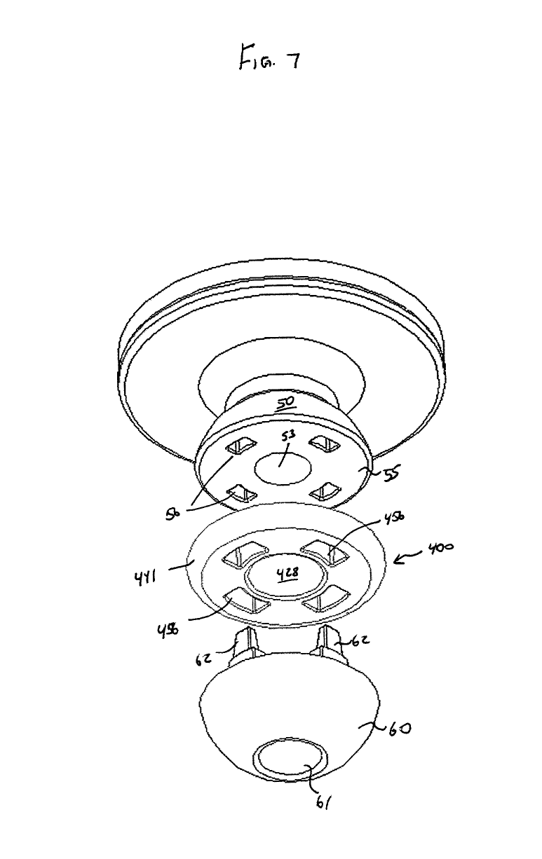

FIGS. 6 and 7 illustrate another embodiment of the present invention that is a modification of the embodiment of FIG. 4. Spherical member 15 is composed of three separate elements as best seen in FIG. 7. First semi-spherical element 50 includes face 55 having a centrally located aperture 53 providing fluid communication to the interior of the housing to which the member 15 is attached. Also provided are a plurality of receiving apertures 56 (four shown). The second element is an integral valve and O-ring assembly 400. The integral assembly 400 includes annular O-ring 441, a plurality of apertures 456 shaped and positioned to align with apertures 56 in first semi-spherical element 50, and a centrally located dome 428 that forms the valve. The dome 428 includes one or more slits as in the previous embodiments. The third element is a second semi-spherical member 60 having an aperture opening 61. The side of the second spherical member 60 opposite the aperture opening 61 includes a plurality of legs 62 adapted to be received by apertures 456 in assembly 500 and apertures 56 in first semi-spherical member 50. Accordingly, the number of legs 62 should correspond to the number of apertures 456 and 56, and the location of the legs should be such that each aligns with a respective aperture 456 and 56 when in the assembled condition of FIG. 6. Preferably the legs 62 form a snap fit in apertures 56.

In the assembled condition of FIG. 6, the integral assembly 400 is sandwiched between the first and second semi-spherical elements in a fluid-sealed condition. The annular O-ring 441 allows for fluid sealing of the member 15 in a manifold or other apparatus. Dome 428 of the valve aligns with aperture opening 61 and includes one or more slits to form the self-sealing valve in the same manner as in the previous embodiments.

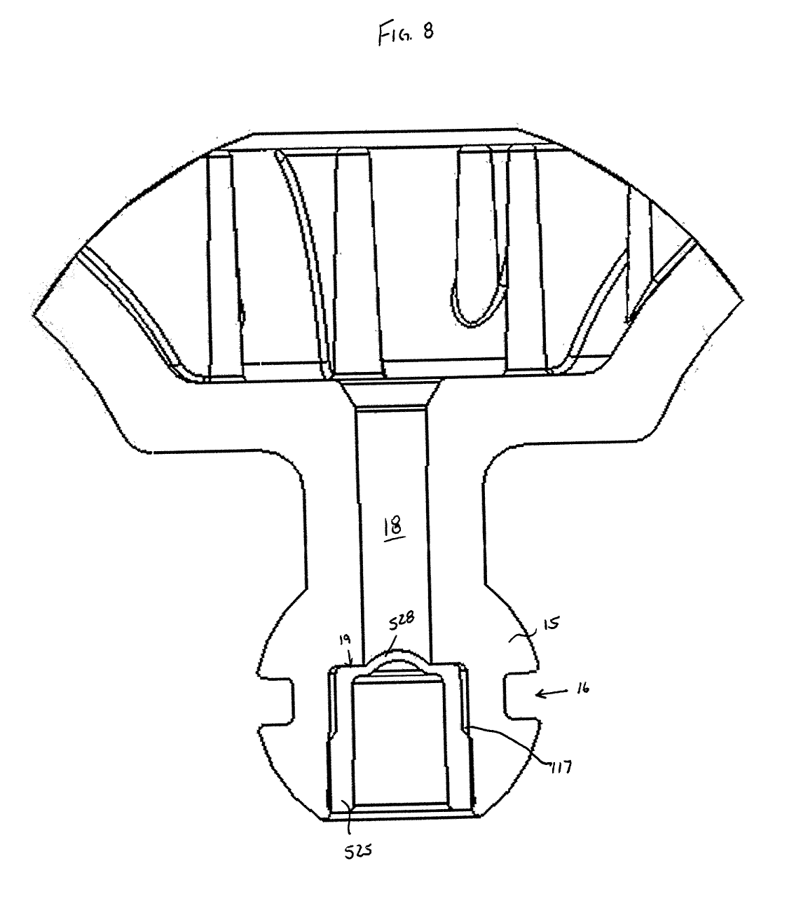

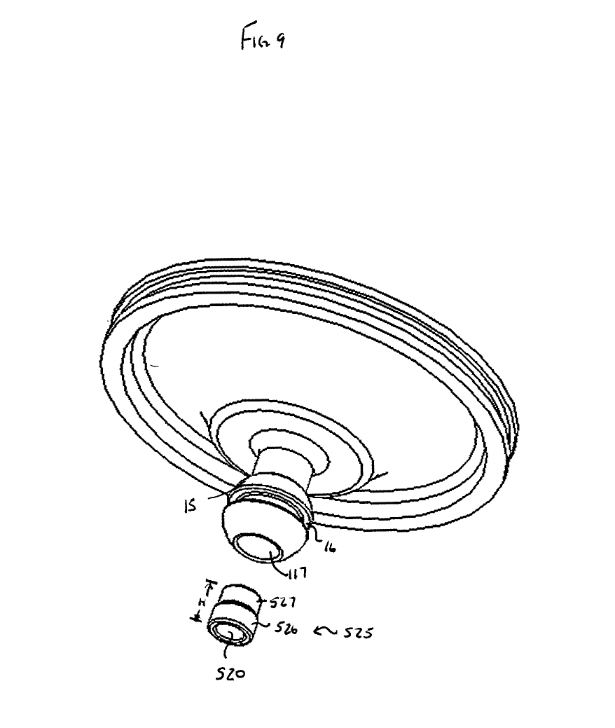

FIGS. 8, 9, 10 and 11 illustrate a preferred embodiment of the present invention. Spherical member 15 is similar to that shown in FIG. 2, and includes annular slot 16 adapted to house an O-ring or the like to seal the spherical member in a corresponding recess in a manifold, for example. Counter bore 117 is in fluid communication with passageway 18 as shown, with passageway 18 preferably having a smaller diameter than bore 117. Housed in bore 117 is valve 525, again preferably made of a resiliently flexible material such as rubber, a thermoplastic elastomer, silicone or urethane, with melt processable rubber being particularly preferred. The location of the valve 525 in this embodiment advantageously minimizes hold-up volume in the filter.

The valve 525 is substantially cylindrical, with a lower portion 526, an angled shoulder 529 and an upper portion 572. The lower portion 526 has an outer diameter greater than the outer diameter of the upper portion 527. The outer diameter of the lower potion 526 is equal to or preferably slightly greater than the inner diameter of the bore 117, so that an interference or press fit is created when the valve 525 is inserted into the inlet 17 as shown in FIG. 8. The outer diameter of the upper portion 527 is slightly less than the inner diameter of the bore 117. The height “H” of the valve 525, measured from the flat marginal portion 530 of the top face 531 of the valve 525, corresponds to the height of the bore 117, so that annular marginal portion 530 of the valve 525 intimately contacts shoulder 19 of the spherical member 15 that separates bore 117 from passageway 18. Dome 525, centrally located on the top face 531, sits in passageway 18 as shown. The valve 525 has a central bore 520 leading to the dome 528.

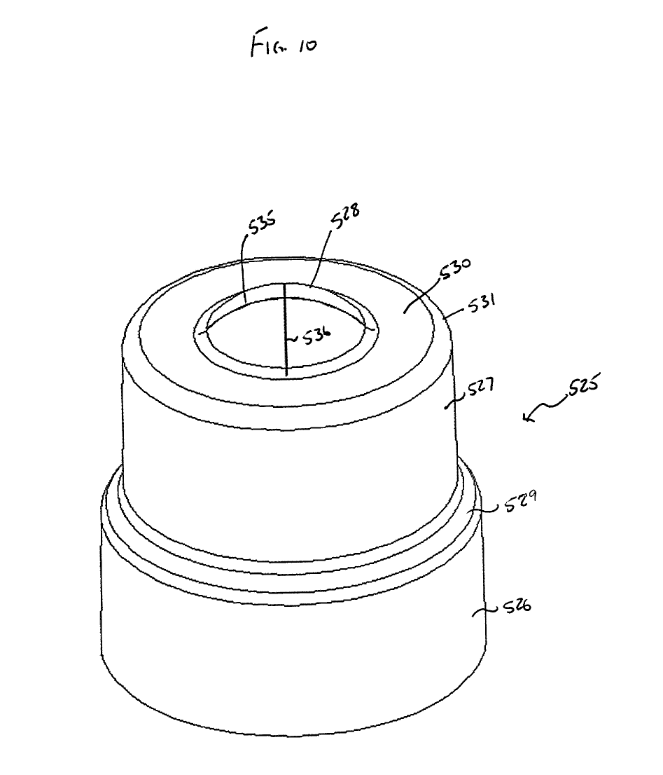

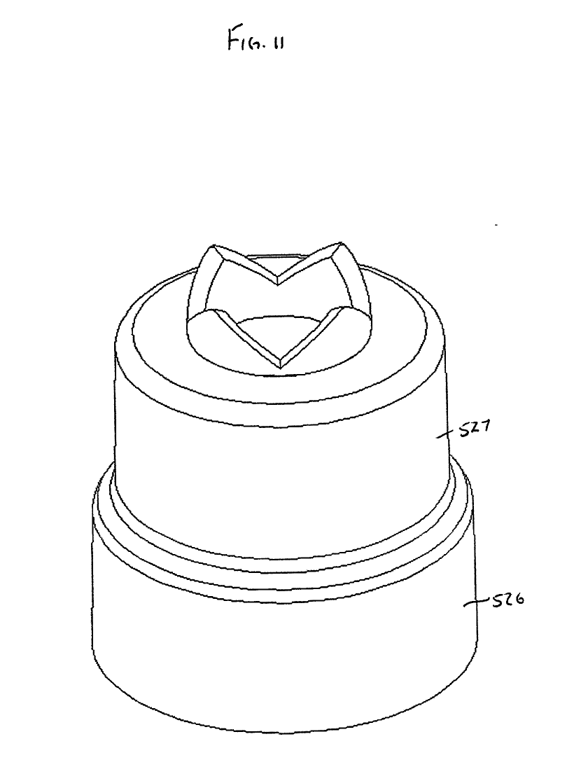

FIG. 10 illustrates slits 535, 536 in the dome 528 in the normally closed position, where the slits are in intimate contact. Upon application of a pressure differential between the outer side of the top face 531 and the inner side of the top face 531 so that a higher pressure is applied to the inner side of the top face, the slits separate as shown in FIG. 11 and allow fluid to flow into passageway 18 from bore 117. A pressure differential applied in the opposite direction would not cause the slits 535, 536 to separate (unless the amount of pressure used exceeds that typical during normal operating conditions, such as during a backwash procedure), and thus the valve 525 prevents fluid from flowing in the opposite direction. For example, when the filter is removed from the process, an insufficient pressure differential is present on the dome 528, and any fluid remaining in the filter is prevented from leaking past the valve 525 and out the inlet 17. Those skilled in the art will appreciate that although two slits are illustrated, dividing the dome into four sections, fewer or more could be used.

The valves of the various embodiments exhibit excellent recovery, allowing for steady, constant flow of fluid in the open position even after multiple openings and closings.

The valves are particularly suited for fluid pass-through applications where replacing displaced fluid with air (venting) is not necessary, such as typical CMP processes. In a typical CMP process, fluid flow is initiated for about 15 minutes at 100-250 ml/min. to prime the system. The cycle is then started, and is on for 1 to 1.5 minutes and then off for 2 to 2.5 minutes (the distribution loop is 20-30 psi or less). The valve assembly must survive a typical run which may be continuous for 1-3 weeks. Similarly, the apparatus may be idle for maintenance or other reason. Typical differential pressures across a clean filter can range from 4 to 7 psi.

What is claimed is:

1. A fluid separations assembly, comprising a housing having separations means and having a fluid inlet and a fluid outlet spaced from said fluid inlet, said housing adapted to receive fluid in said inlet, pass said fluid through said separations means and out said outlet; a self-sealing valve downstream of at least one of said inlet or outlet, said valve configured to open and allow fluid flow in a first direction through said housing upon the application of a first pressure differential having a certain magnitude, and prevent fluid flow in a second direction different from said first direction upon the application of a second pressure differential having the same certain magnitude.

2. The filter separations assembly of claim 1, wherein said first direction is the direction from said inlet to said outlet.

3. The filter separations assembly of claim 2, wherein said second direction is the direction from said outlet to said inlet.

4. The filter separations assembly of claim 1, wherein said valve comprises a marginal portion and a domed portion, said domed portion having one or more slits that in intimate contact in a normally closed position and that are adapted to separate upon application of said first pressure differential.

5. The filter separations assembly of claim 1, wherein said first pressure differential is in the range of between 4 and 7 psi.

6. The filter separations assembly of claim 1, wherein said inlet comprises a spherical member having a bore, and wherein said valve is seated in said bore.

7. An end cap for a separations device having separations media contained in said device, comprising:
a coupling member having a fluid passage adapted to be in fluid communication with said separations media, said fluid passage having an inlet; and
a valve in said end cap, said valve having a first side facing said inlet and a second side opposite said first side, said valve being adapted to open to allow fluid flow from said inlet to said separations media in response to a positive pressure differential applied to said first side relative to said second side and adapted to remain closed to prevent fluid flow from said separations media to said inlet in response to a positive pressure differential applied to said second side relative to said first side.

8. The end cap of claim 7, wherein said positive pressure differential applied to said first side is generated by the flow of fluid entering said inlet.

9. An end cap for a separations device having separations media contained in said device, comprising:
a coupling member having a fluid passage adapted to be in fluid communication with said separations media, said fluid passage having an outlet; and
a valve in said end cap, said valve having a first side facing said outlet and a second side opposite said first side, said valve being adapted to open to allow fluid flow from said separations media to said outlet in response to a positive pressure differential applied to said second side relative to said first side and adapted to remain closed to prevent fluid flow from said outlet to said separations media in response to a positive pressure differential applied to said first side relative to said second side.

10. The end cap of claim 9, wherein said positive pressure differential applied to said second side is generated by the flow of fluid from said separations media to said outlet.
